(19) United States
(12) Patent Application Publication
(10) Pub. No.: US 2008/0239144 A1
(43) Pub. Date: Oct. 2, 2008

(54) FRAME RATE CONVERSION DEVICE AND IMAGE DISPLAY APPARATUS

(75) Inventors: Susumu TANASE, Kadoma City (JP); Takaaki Abe, Osaka City (JP); Masutaka Inoue, Hirakata City (JP)

Correspondence Address: NDQ&M WATCHSTONE LLP, 1300 EYE STREET, NW, SUITE 1000 WEST TOWER, WASHINGTON, DC, 20005, US

(73) Assignee: Sanyo Electric Co., Ltd., Moriguchi City (JP)

(21) Appl. No.: 12/055,816

(22) Filed: Mar. 26, 2008

(30) Foreign Application Priority Data
Mar. 27, 2007 (JP) JP2007-082143

(51) Int. Cl. H04N 7/01

(52) U.S. Cl. 348/441; 348/E07.003

(57) ABSTRACT

An interpolation frame generation unit includes a first unit that uses, with respect to each of pixel positions, which are determined to be a motionless region by a region determination unit, in an interpolation frame, any of an image at the same pixel position in the preceding frame, an image at the same pixel position in the current frame, and an average of the images at the same pixel position in the preceding frame and the current frame as an interpolated image at the pixel position, and a second unit that extracts, with respect to each of pixel positions, which are determined to be a motion region by the region determination unit, in the interpolation frame, an image corresponding to the pixel position in the interpolation frame from either one of the preceding frame and the current frame on the basis of a motion vector for a block including the pixel position and uses the extracted image as an interpolated image.

### BACKGROUND OF THE INVENTION

1. Field of the Invention

The present invention relates to a frame rate conversion device and an image display apparatus including the same.

2. Description of Related Art

Image display apparatuses that can display contents at higher frame rates than the existing contents have been developed. For example, as liquid crystal televisions, ones that convert images in 60 frames per second into images in 120 frames per second and display the obtained images in 120 frames per second on liquid crystal displays have been developed in order to prevent moving images from being blurred. When the contents are displayed on such image display apparatuses, smooth reproduced images are obtained by not merely outputting an image in the same frame a plurality of times but generating interpolated images between frames by means of signal processing and inserting the generated interpolated images between the frames.

Examples of conventional technologies of interpolations between frames include technologies disclosed in Japanese Unexamined Patent Publication No. 2004-357215 and Japanese Unexamined Patent Publication No. 2005-176381.

Conventionally, when interpolation between frames is performed, a screen has been divided into a plurality of blocks, and a motion vector has been calculated for each of the blocks, to generate an interpolated image on the basis of the motion vector for the obtained block. Alternatively, the corresponding block has been selected by block matching, to perform interpolation between frames.

In a method of calculating a motion vector for each of blocks and determining an interpolated image for the block, the contour of an object in the interpolated image is disadvantageously easily distorted.

### SUMMARY OF THE INVENTION

An object of the present invention is to provide a frame rate conversion device in which an interpolated image including an object whose contour is hardly distorted is obtained and an image display apparatus including the same.

According to an aspect of the present invention, a frame rate conversion device includes a motion vector detection unit that divides a region in the current frame into a plurality of blocks and calculates for each of the blocks a motion vector between the preceding frame and the current frame, a region determination unit that determines for each of pixels composing the current frame whether the position of the pixel is a motion region or a motionless region on the basis of the value of the pixel in the current frame and the value of a corresponding pixel in the preceding frame, and an interpolation frame generation unit that generates an interpolation frame on the basis of the current frame, the preceding frame, the motion vector for each of the blocks detected by the motion vector detection unit, and the result of the region determination by the region determination unit, in which the interpolation frame generation unit includes a first unit that uses, with respect to each of the pixel positions, which are determined to be the motionless region by the region determination unit, in the interpolation frame, any of an image at the same pixel position in the preceding frame, an image at the same pixel position in the current frame, and an average of the images at the same pixel position in the preceding frame and the current frame as an interpolated image at the pixel position, and a second unit that extracts, with respect to each of the pixel positions, which are determined to be the motion region by the region determination unit, in the interpolation frame, an image corresponding to the pixel position in the interpolation frame from either one of the preceding frame and the current frame on the basis of the motion vector for the block including the pixel position and uses the extracted image as an interpolated image.

An example of the region determination unit is one that determines for each of the pixels composing the current frame whether the position of the pixel is the motion region or the motionless region on the basis of the result of comparison of a difference absolute value in the pixel between the current frame and the preceding frame with a threshold value and the motion vector for the block including the pixel.

An example of the second unit is one including a third unit that selects, for each of the pixel positions determined to be the motion region by the region determination unit, the current frame or the preceding frame from which the image corresponding to the pixel position in the interpolation frame is to be extracted on the basis of a history of the results of the region determination for the pixel positions, and a fourth unit that extracts, for each of the pixel positions determined to be the motion region by the region determination unit, the image corresponding to the pixel position in the interpolation frame from the frame selected by the third unit on the basis of the motion vector for the block including the pixel position and uses the extracted image as an interpolated image.

An example of the third unit is one including a unit that determines, for each of the pixel positions determined to be the motion region by the region determination unit, which of a first region where motion is terminated, a second region where motion is continued and a third region where motion is started the pixel position corresponds to on the basis of the history of the results of the region determination for the pixel positions, and a unit that selects, for the pixel position determined to correspond to the first region, the current frame as a frame from which an image corresponding to the pixel position in the interpolation frame is to be extracted, while selecting, for the pixel position determined to correspond to the second region or the third region, the preceding frame as a frame from which an image corresponding to the pixel position in the interpolation frame is to be extracted.

An image display apparatus according to the present invention includes the above-mentioned frame rate conversion device.

Other features, elements, characteristics, and advantages of the present invention will become more apparent from the following description of preferred embodiments of the present invention with reference to the attached drawings.

### BRIEF DESCRIPTION OF THE DRAWINGS

FIG. 1 is a block diagram showing the electrical configuration of a frame rate conversion device;

FIGS. 2A to 2F are schematic views for explaining region determination processes carried out by a region determiner 5;

FIG. 3 is a flow chart showing the procedure for the region determination processes carried out by the region determiner 5;

FIG. 4 is a schematic view showing that a signal value for a target pixel in the n-th frame is represented by Pₙ(x, Y);

FIG. 5 is a schematic view for explaining interpolated image data generation processes carried out by a motion region interpolator 7;

FIG. 6 is a schematic view showing in a region B, a region where a subject image is selected (the region B and a “subject” region) and a region where a background image is selected (the region B and a “background” region);

FIG. 7 is a flow chart showing the procedure for the interpolated image data generation processes carried out by the motion region interpolator 7; and

FIG. 8 is a schematic view showing images in the (n−2)-th frame, (n−1)-th frame, n-th frame, and (n+1)-th frame, the result of motion determination for each of pixels in each of the frames, and the result of determination which of regions A to D each of pixel positions corresponds to on the basis of a history of the results of motion determination.

### DETAILED DESCRIPTION OF THE PREFERRED EMBODIMENT

[1] Electrical configuration of frame rate conversion device

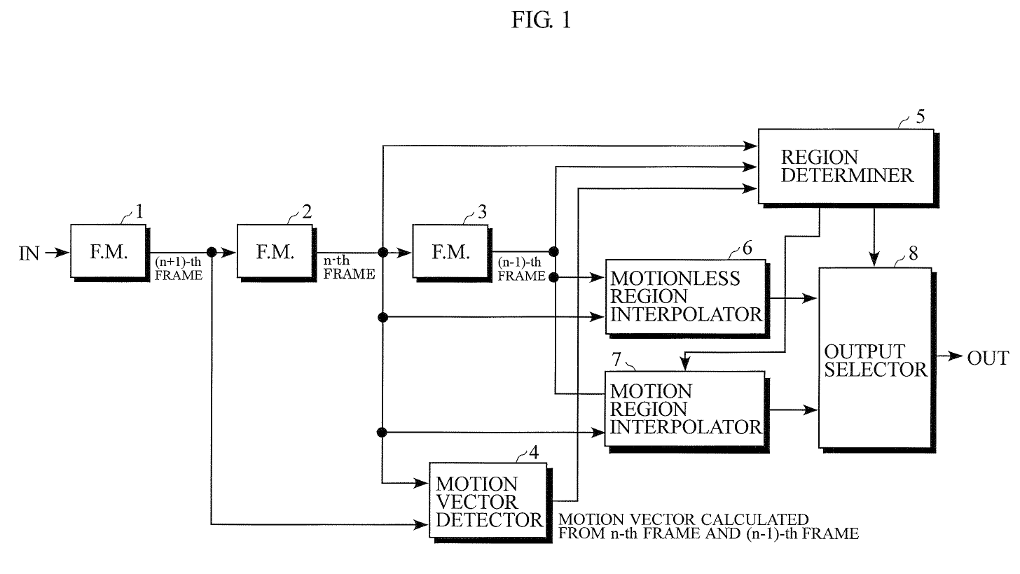

FIG. 1 shows the electrical configuration of a frame rate conversion device.

The frame rate conversion device includes three frame memories 1, 2, and 3, a motion vector detector 4, a region determiner 5, a motionless region interpolator 6, a motion region interpolator 7, and an output selector 8.

An input image signal is fed to the first frame memory 1. The input image signal fed to the first frame memory 1 is fed to the second frame memory 2 and is fed to the motion vector detector 4 after being delayed by one frame period.

The input image signal fed to the second frame memory 2 is fed to the third frame memory 3, the motion vector detector 4, the region determiner 5, the motionless region interpolator 6, and the motion region interpolator 7 after being delayed by one frame period.

The input image signal fed to the third frame memory 3 is fed to the region determiner 5, the motionless region interpolator 6, and the motion region interpolator 7 after being delayed by one frame period.

A frame number outputted from the first frame memory 2, a frame number outputted from the second frame memory 2, and a frame number outputted from the third frame memory 2 are respectively taken as n+1, n, and n−1.

[1] Motion Vector Detector 4

The motion vector detector 4 calculates a motion vector between two adjacent frames. Specifically, a screen is divided into a plurality of blocks, and a motion vector is calculated for each of the blocks by a block matching method or a representative point matching method. The motion vector for each of the blocks calculated by the motion vector detector 4 is outputted to the region determiner 5 after being delayed by one frame period.

[3] Region Determiner 5

The region determiner 5 compares the (n−1)-th frame and the n-th frame, to determine for each of pixels whether the position of the pixel is a motion region or a motionless region.

In principle, a difference absolute value between the (n−1)-th frame and the n-th frame is compared with a threshold value a for each of the pixels, to determine that the position of the pixel in which the difference absolute value is not less than the threshold value a is a motion region and determine that the position of the pixel in which the difference absolute value is less than the threshold value a is a motionless region.

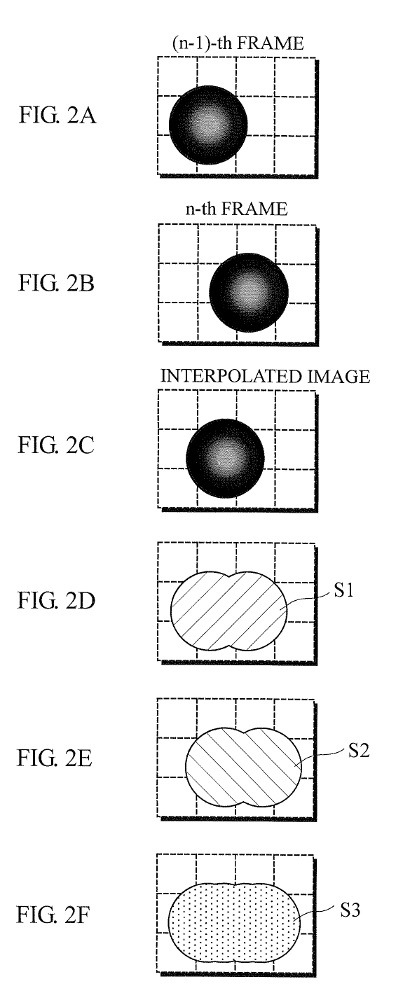

When respective images in the (n−1)-th frame and the n-th frame are images as shown in FIGS. 2A and 2B, an ideal interpolated image is as shown in FIG. 2C. The motion region based on the difference absolute value is a region S1 as indicated by hatching in FIG. 2D. Comparison between FIGS. 2C and 2D shows that a part of the display position of an object that moves on the ideal interpolated image is not included in the motion region based on the difference absolute value. Therefore, the motion region S1 based on the difference absolute value is shifted depending on the motion vector, and a region that is the logical OR of the motion region based on the difference absolute value and a region after the shifting is taken as a final motion region.

FIG. 2E shows a region S2 obtained by shifting the motion region S1 based on the difference absolute value by one-half of the motion vector in the direction of the motion vector. FIG. 2F shows a region S3 that is the logical OR of the motion region S1 based on the difference absolute value and the region S2 after the shifting.

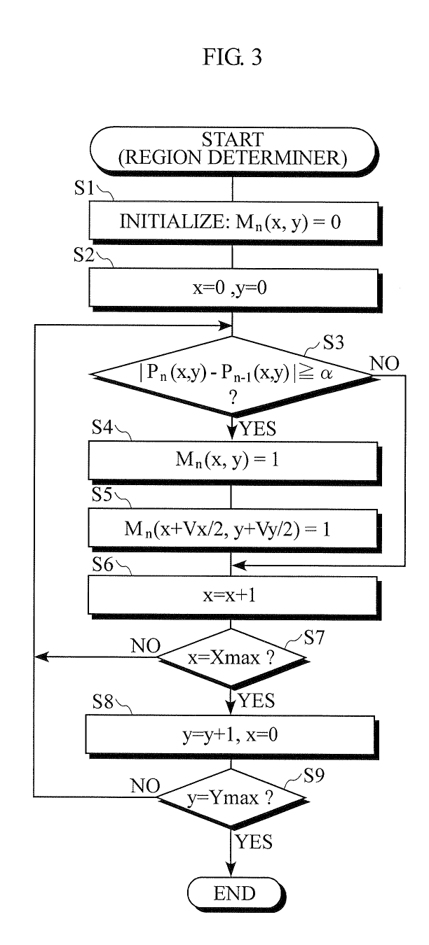

FIG. 3 shows the procedure for region determination processes carried out by the region determiner 5.

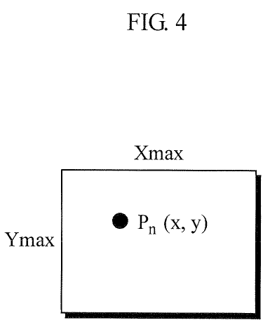

Referring to FIG. 4, let Xₘₐₓ and Yₘₐₓ respectively be the number of pixels in the horizontal direction and the number of pixels in the vertical direction in one frame. A signal value for a target pixel (x, y) in the n-th frame is represented by Pₙ(x, y). Similarly, a signal value for a target pixel (x, y) in the (n−1)-th frame is represented by Pₙ₋₁(x, y). Furthermore, a motion vector for the target pixel (x, y) is represented by (Vx, Yv). The result of determination for the target pixel (x, y) is represented by Mₙ(x, y). Mₙ(x, y) takes a value of “1” when the position of the pixel is determined to be a motion region, while taking a value of “0” when the position of the pixel is determined to be a motionless region.

First, Mₙ(x, y) is initialized to zero (step S1). That is, the results of determination for all the pixels are set to zero. Thereafter, x=0 and y=0 are set (step S2). Then, it is determined whether or not a difference absolute value between the signal value Pₙ(x, y) corresponding to the target pixel (x, y) in the n-th frame and the signal value Pₙ₋₁(x, y) corresponding to the target pixel (x, y) in the (n−1)-th frame is not less than a threshold value a (step S3). That is, it is determined whether or not conditions expressed by the following equation (1) are satisfied:

|Pₙ(x,y)−Pₙ₋₁(x,y)|≧α (1)

When the conditions expressed by the foregoing equation (1) are satisfied, the value of Mₙ(x, y) that is the result of determination for the target pixel (x, y) is set to “1” (step S4). Furthermore, the value of Mₙ(x+Vx/2, y+Vy/2) that is the result of determination for the position of a pixel obtained by shifting the target pixel (x, y) in the direction of a motion vector (Vx, Vy) corresponding thereto by one-half of the motion vector (Vx, Vy) is set to “1” (step S5). The procedure then proceeds to the step S6.

When it is determined in the step S3 that the conditions expressed by the foregoing equation (1) are not satisfied, the procedure proceeds to the step S6 without performing the processes in the steps S4 and S5.

In the step S6, x is incremented by one in order to shift the position in the horizontal direction of the target pixel by one pixel. It is then determined whether or not x=Xₘₐₓ (step S7). If x=Xₘₐₓ is not established, that is, if x is less than Xₘₐₓ, the procedure is returned to the step S3.

When it is determined in the step S7 that x=Xₘₐₓ, y is incremented by one and x is set to zero in order to shift the position in the vertical direction of the target pixel by one pixel as well as to return the position in the horizontal direction of the target pixel to the front (step S8). It is determined whether or not Y=Yₘₐₓ (step S9). If y=Yₘₐₓ is not established, that is, if y is less than Yₘₐₓ, the procedure is returned to the step S3.

When it is determined in the step S9 that y=Yₘₐₓ, the current region determination processes are terminated.

The result of the region determination by the region determiner 5 is sent to the motion region interpolator 7 and the output selector 8.

[4] Motionless region interpolator 6

The motionless region interpolator 6 calculates, for each of target pixels composing an interpolated image, an interpolated image datum in a case where it is assumed that the position of the pixel is a motionless region. Specifically, letting P(x, y) be an image datum for the target pixel in the interpolated image, an average of the image data in the n-th frame and the (n−1)-th frame is used. That is, the image datum P(x, y) in the interpolated image is calculated for each of the target pixels on the basis of the following equation (2).

P(x,y)={Pₙ(x,y)+Pₙ₋₁(x,y)}/2 (2)

Note that as the image datum P(x, y) for the target pixel in the interpolated image, an image datum Pₙ(x, y) for the target pixel in the n-th frame or an image datum Pₙ₋₁(x, y) for the target pixel in the (n−1)-th frame may be used.

[5] Motion region interpolator 7

The motion region interpolator 7 calculates, for each of target pixels in an interpolated image, an interpolated image datum in a case where it is assumed that the position of the pixel is a motion region.

Letting (x, y) be a target pixel in an interpolation frame and (Vx, Vy) be a motion vector for the target pixel (x, y), an image datum for the target pixel (x, y) is determined by one of the following three equations (3), (4), and (5):

P(x,y)=Pₙ{x+(Vx/2),y+(Vy/2)} (3)

P(x,y)=Pₙ₋₁{x−(Vx/2),y−(Vy/2)} (4)

P(x,y)={Pₙ(x,y)+Pₙ₋₁(x,y)}/2 (5)

It is determined which of the equations (3), (4), and (5) should be used to calculate the image datum for the target pixel (x, y) on the basis of a history of the results of motion determination for the target pixel. That is, an equation to be used for calculating an image datum is determined on the basis of a motion determination result Mₙ(x, y) for a target pixel in the current frame n, a motion determination result Mₙ₊₁(x, y) for a target pixel in a frame (n+1) succeeding the current frame n, a motion determination result Mₙ₋₁(x, y) for a target pixel in a frame (n−1) preceding the current frame n, and a motion determination result Mₙ₋₂(x, y) for a target pixel in a frame (n−2) preceding the frame (n−1).

More specifically, it is determined which of the following four regions A, B, C, and D the target pixel corresponds to on the basis of the history of the results of motion determination for the target pixel:

A: a region where motion is terminated (a region through which an object has passed)

B: a region where motion is continued (a region through which an object is passing)

C: a region where motion is started (a region which an object has entered)

D: a motionless region

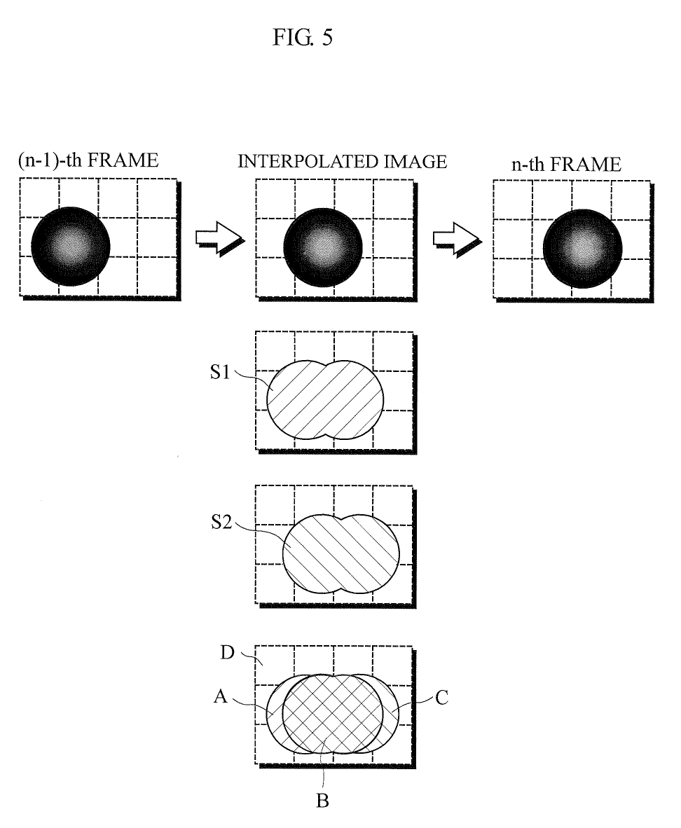

FIG. 5 shows an image (an image corresponding to FIG. 2A) in the (n−1)-th frame, an image (an image corresponding to FIG. 2B) in the n-th frame, an ideal interpolated image (an image corresponding to FIG. 2C) generated from both the frames, an image (an image corresponding to FIG. 2D) representing a motion region S1 based on a difference absolute value, an image (an image corresponding to FIG. 2E) representing a region S2 obtained by shifting the region S1 depending on a motion vector, and an image representing regions respectively corresponding to the regions A to D.

NotS1 is defined as a region other than the region S1, and notS2 is defined as a region other than the region S2. The region A is a region that is the logical product (AND) of S1 and notS2. The region B is a region that is the logical product of S1 and S2. The region C is a region that is the logical product of notS1 and S2. The region D is a region that is the logical product of notS1 and notS2.

Since the region A is a region through which an object has passed, not a subject image but a background image should be displayed as an interpolated image. The background image does not exist in the (n−1)-th frame because it is concealed by a subject in the (n−1)-th frame. When the target pixel corresponds to the region A, therefore, motion compensation is provided using the n-th frame, to calculate an interpolated image datum. That is, the interpolated image datum is calculated on the basis of the foregoing equation (3).

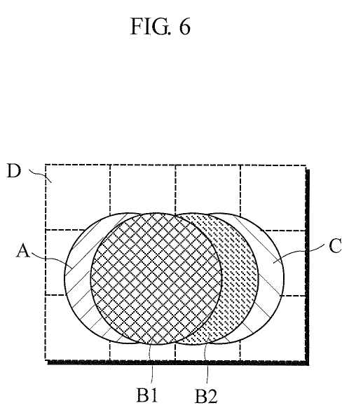

Since the region B is a region through which an object is passing, a subject image and a background image should be displayed as an interpolated image. As shown in FIG. 6, there is no problem in a region B1 where the subject image is selected (the region B and a “subject” region), while the background image does not exist in the n-th frame because it is concealed by a subject in the n-th frame in a region B2 where the background image is selected (the region B and a “background” region). When the target pixel corresponds to the region B, therefore, motion compensation is provided using the (n−1)-th frame, to calculate an interpolated image datum. That is, the interpolated image datum is calculated on the basis of the foregoing equation (4).

Since the region C is a region which an object has entered, not a subject image but a background image should be displayed as an interpolated image. The background image does not exist in the n-th frame because it is concealed by a subject in the n-th frame. When the target pixel corresponds to the region C, therefore, motion compensation is provided using the (n−1)-th frame, to calculate an interpolated image datum. That is, the interpolated image datum is calculated on the basis of the foregoing equation (4).

Since the region D is a motionless region, an average of image data in the n-th frame and the (n−1)-th frame is taken as an interpolated image datum. That is, the interpolated image datum is calculated on the basis of the foregoing equation (5).

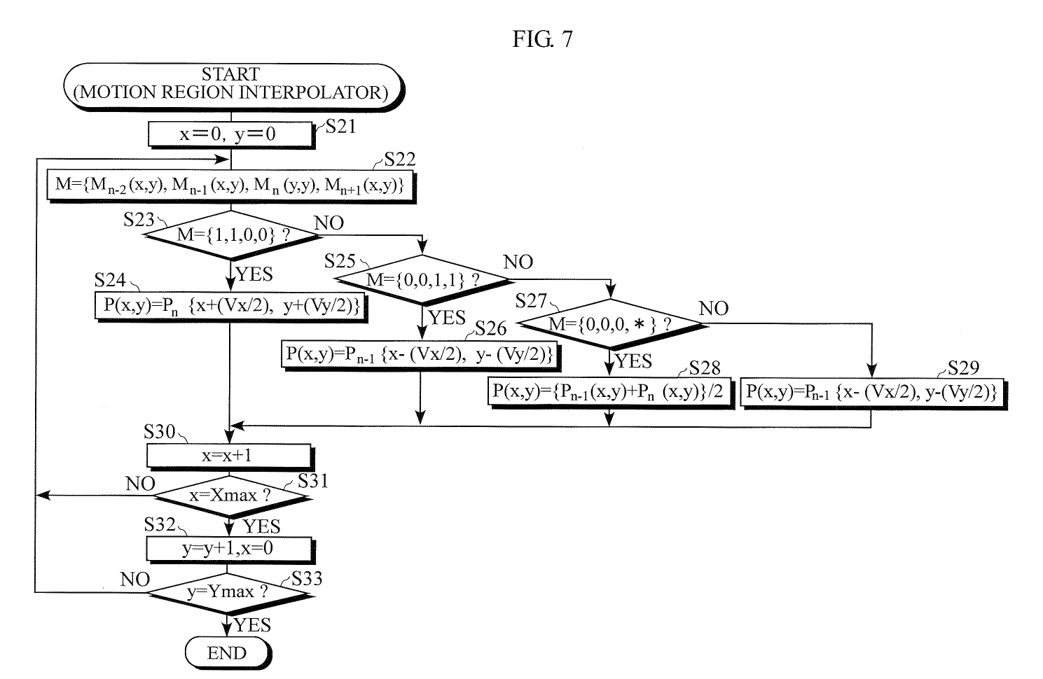

FIG. 7 shows the procedure for interpolated image data generation processes carried out by the motion region interpolator 7.

First, x=0 and y=0 are set (step S21). A history M={Mₙ₋₂(x, y), M_{N-1}(x, y), Mₙ(x, y), M_{N+1}(x, y)} of the results of motion determination for the target pixel is found (step S22).

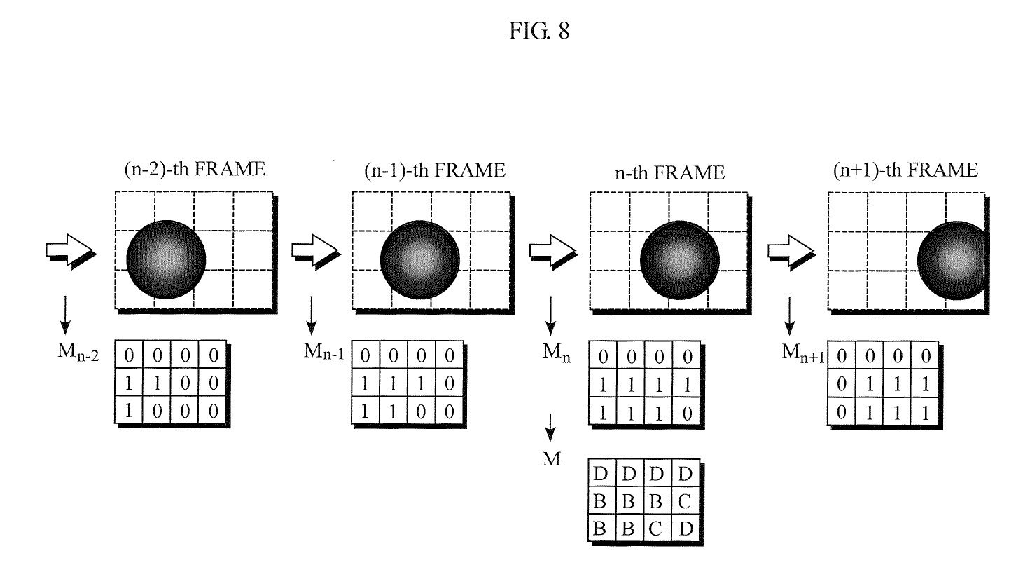

FIG. 8 shows respective images in the (n−2)-th frame, (n−1)-th frame, n-th frame, and (n+1)-th frame, and shows the result of motion determination for each of pixels in each of the frames. Furthermore, FIG. 8 shows the result of determination which of the regions A to D the position of each of the pixels corresponds to on the basis of the history of the results of motion determination. However, no pixel corresponds to the region A in this example.

After the foregoing step S22, it is determine whether or not M={1, 1, 0, 0} (step S23). When it is determined that M={1, 1, 0, 0}, it is determined that the position of a target pixel (x, y) corresponds to the region A (the region through which an object has passed), to calculate an interpolated image datum P(x, y) for the target pixel (x, y) on the basis of the foregoing equation (3) (step S24). The procedure proceeds to the step S30.

When it is not determined in the step S23 that M={1, 1, 0, 0}, it is determined whether or not M={0, 0, 1, 1} (step S25). When it is determined that M={0, 0, 1, 1}, it is determined that the position of the target pixel (x, y) corresponds to the region C (the region which an object has entered), to calculate an interpolated image datum P(x, y) for the target pixel (x, y) on the basis of the foregoing equation (4) (step S26). The procedure proceeds to the step S30.

When it is not determined in the step S25 that M={0, 0, 1, 1}, it is determined whether or not M={0, 0, 0, *} (step S27). Note that * is a sign indicating that it may be zero or one. When it is determined that M={0, 0, 0, *}, it is determined that the position of the target pixel (x, y) corresponds to the region D (the motionless region), to calculate an interpolated image datum P(x, y) for the target pixel (x, y) on the basis of the foregoing equation (5) (step S28). The procedure proceeds to the step S30.

When it is not determined in the step S27 that M={0, 0, 0, *}, it is determined that the position of the target pixel (x, y) corresponds to the region B (the region through which an object is passing), to calculate an interpolated image datum P(x, y) for the target pixel (x, y) on the basis of the foregoing equation (4) (step S29). The procedure proceeds to the step S30.

In the step S30, x is incremented by one in order to shift the position in the horizontal direction of the target pixel by one pixel. It is then determined whether or not x=Xₘₐₓ (step S31). If x=Xₘₐₓ is not established, that is, if x is less than Xₘₐₓ, the procedure is returned to the step S22.

When it is determined in the step S31 that x=Xₘₐₓ, y is incremented by one and x is set to zero (step S32) in order to shift the position in the vertical direction of the target pixel by one pixel as well as to return the position in the horizontal direction of the target pixel to the front. It is determined whether or not y=Yₘₐₓ (step S33). If Y=Yₘₐₓ is not established, that is, if y is less than Yₘₐₓ, the procedure is returned to the step S22.

When it is determined in the step S33 that Y=Yₘₐₓ, the current interpolation processes are terminated.

[6] Output selector 8

The output selector 8 switches an output from the motionless region interpolator 6 and an output from the motion region interpolator 7 depending on the result of the determination by the region determiner 5. That is, the output from the motion region interpolator 7 is selected for a pixel whose position is determined to be a motion region by the region determiner 5, while the output from the motionless region interpolator 6 is selected for a pixel whose position is determined to be a motionless region by the region determiner 5. This causes an interpolated image to be outputted from the output selector 8.

While preferred embodiments of the present invention have been described above, it is to be understood that variations and modifications will be apparent to those skilled in the art without departing the scope and spirit of the present invention. The scope of the present invention, therefore, is to be determined solely by the following claims.

What is claimed is:

1. A frame rate conversion device comprising:
a motion vector detection unit that divides a region in a current frame into a plurality of blocks and calculates for each of the blocks a motion vector between a preceding frame and the current frame;
a region determination unit that determines for each of pixels composing the current frame whether a position of the pixel is a motion region or a motionless region on the basis of a value of the pixel in the current frame and a value of a corresponding pixel in the preceding frame; and
an interpolation frame generation unit that generates an interpolation frame on the basis of the current frame, the preceding frame, the motion vector for each of the blocks detected by the motion vector detection unit, and a result of the region determination by the region determination unit,
wherein the interpolation frame generation unit comprises
a first unit that uses, with respect to each of the pixel positions, which are determined to be the motionless region by the region determination unit, in the interpolation frame, any of an image at the same pixel position in the preceding frame, an image at the same pixel position in the current frame, and an average of the images at the same pixel position in the preceding frame and the current frame as an interpolated image at the pixel position, and
a second unit that extracts, with respect to each of the pixel positions, which are determined to be the motion region by the region determination unit, in the interpolation frame, an image corresponding to the pixel position in the interpolation frame from either one of the preceding frame and the current frame on the basis of the motion vector for the block including the pixel position and uses the extracted image as an interpolated image.

2. The frame rate conversion device according to claim 1, wherein
the region determination unit determines for each of the pixels composing the current frame whether the position of the pixel is the motion region or the motionless region on the basis of a result of comparison of a difference absolute value in the pixel between the current frame and the preceding frame with a threshold value and the motion vector for the block including the pixel.

3. The frame rate conversion device according to claim 1, wherein
the second unit comprises
a third unit that selects, for each of the pixel positions determined to be the motion region by the region determination unit, the current frame or the preceding frame from which an image corresponding to the pixel position in the interpolation frame is to be extracted on the basis of a history of results of the region determination for the pixel positions, and
a fourth unit that extracts, for each of the pixel positions determined to be the motion region by the region determination unit, an image corresponding to the pixel position in the interpolation frame from the frame selected by the third unit on the basis of the motion vector for the block including the pixel position and uses the extracted image as an interpolated image.

4. The frame rate conversion device according to claim 3, wherein
the third unit comprises
a unit that determines, for each of the pixel positions determined to be the motion region by the region determination unit, which of a first region where motion is terminated, a second region where motion is continued and a third region where motion is started the pixel position corresponds to on the basis of the history of the results of the region determination for the pixel positions, and
a unit that selects, for the pixel position determined to correspond to the first region, the current frame as a frame from which an image corresponding to the pixel position in the interpolation frame is to be extracted, while selecting, for the pixel position determined to correspond to the second region or the third region, the preceding frame as a frame from which an image corresponding to the pixel position in the interpolation frame is to be extracted.

5. An image display apparatus comprising the frame rate conversion device according to claim 1.
